(19) United States
(12) Patent Application Publication
(10) Pub. No.: US 2009/0023328 A1
(43) Pub. Date: Jan. 22, 2009

(54) BURGLARPROOF SOCKET EXHIBITION ASSEMBLY

(76) Inventor: Tsung-Da Lin, Taichung County (TW)

Correspondence Address: Tsung- Da Lin, Box 8-24, 235 Chung - Ho, Taipei, TW

(21) Appl. No.: 11/778,067

(22) Filed: Jul. 16, 2007

(51) Int. Cl. H01R 4/24

(52) U.S. Cl. 439/387

(57) ABSTRACT

A burglarproof socket exhibition assembly, comprises a head; a body installed to a lower end of the head; the body having a cylindrical structure; the body having a hollow channel; a front side of the hollow channel of the body having a first rib and a rear side of the hollow channel of the body having a second rib; the first rib having a position higher than that of the second rib; and each of two sides of the front end of the body having a protrusion; the two protrusions being at two opposite sides of the hollow channel, each of two sides of the rear end of the body having a protrusion; and the two protrusions being at two opposite sides of the hollow channel. It is very difficult to take the socket from the burglarproof socket exhibition assembly so that it has the effect of burglarproof.

### FIELD OF THE INVENTION

The present invention relates to socket exhibition devices, and particularly to a burglarproof socket exhibition assembly which can firmly secure a socket with a lower manufacturing cost. It is very difficult to take the socket from the burglarproof socket exhibition assembly so that it has the effect of burglarproof.

### BACKGROUND OF THE INVENTION

For selling the sockets, in the stores for selling sockets, the sockets are exhibited. However, in the prior art the sockets are exhibited freely so that the burglar can take it down from a display panel easily. Thus some burglarproof socket exhibition assemblies are developed.

In one prior art, the exhibition panel has a groove. The groove is formed with buckles for buckling the sockets. The buckle is formed by at least one resisting portion. The resisting portion has a protrusion. However, the prior art structure has a large size and thus it is not suitable for various exhibition locations. Furthermore the affect of burglarproof of this portion is not as good as required. It can be drawn away from the panel if a larger force is applied.

Therefore, there is an eager demand for a novel design which can improve the defect in the prior art structure.

### SUMMARY OF THE INVENTION

Accordingly, the primary object of the present invention is to provide a burglarproof socket exhibition assembly which can firmly secure a socket with a lower manufacturing cost. It is very difficult to take the socket from the burglarproof socket exhibition assembly so that it has the effect of burglarproof.

To achieve above objects, the present invention provides a burglarproof socket exhibition assembly, comprising: a head; a body installed to a lower end of the head; the body having a cylindrical structure; the body having a hollow channel; a front side of the hollow channel of the body having a first rib and a rear side of the hollow channel of the body having a second rib; the first rib having a position higher than that of the second rib; and each of two sides of the front end of the body having a protrusion; the two protrusions being at two opposite sides of the hollow channel, each of two sides of the rear end of the body having a protrusion.

The first rib is connected to the second rib by using a bar. A middle section of the first rib is reduced so as to have a small size to form a cutting portion. An upper end of the head is an exhibition unit. The exhibition unit has a slot for suspending the exhibition assembly to an object. Each rib is not adhered to a wall of the hollow channel so that gaps are formed between the ribs and the hollow channel; and the gap provides a space for compressing the body inwards.

The various objects and advantages of the present invention will be more readily understood from the following detailed description when read in conjunction with the appended drawing.

### BRIEF DESCRIPTION OF THE DRAWINGS

FIG. 1 is a perspective view of the burglarproof socket exhibition assembly of the present invention.

FIG. 2A is a plane view of the burglarproof socket exhibition assembly of the present invention.

FIG. 2B is a schematic cross sectional view of the burglarproof socket exhibition assembly of the present invention, which is illustrated along line AB of FIG. 2A.

FIG. 3 is a perspective view showing the structure of the present invention with a socket to be applied.

FIG. 4 is a schematic view showing the operation of the present invention.

FIG. 5A is a schematic cross sectional view showing that the body of the present invention is installed within a socket.

FIG. 5B is a schematic cross sectional view along line AB of FIG. 5A.

FIG. 6A is a schematic view showing the cutting operation according to the present invention.

FIG. 6B is a schematic view showing that the cutting portion of the present invention has been cut.

FIG. 6C is a schematic cross sectional view along line AB of FIG. 6B.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

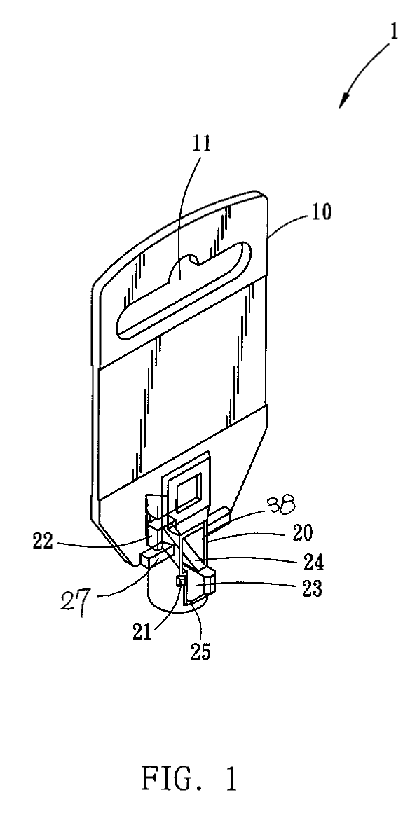

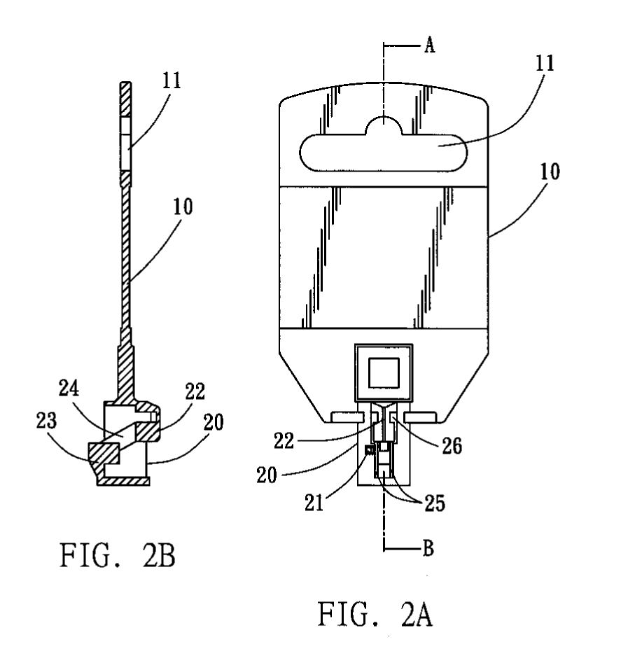

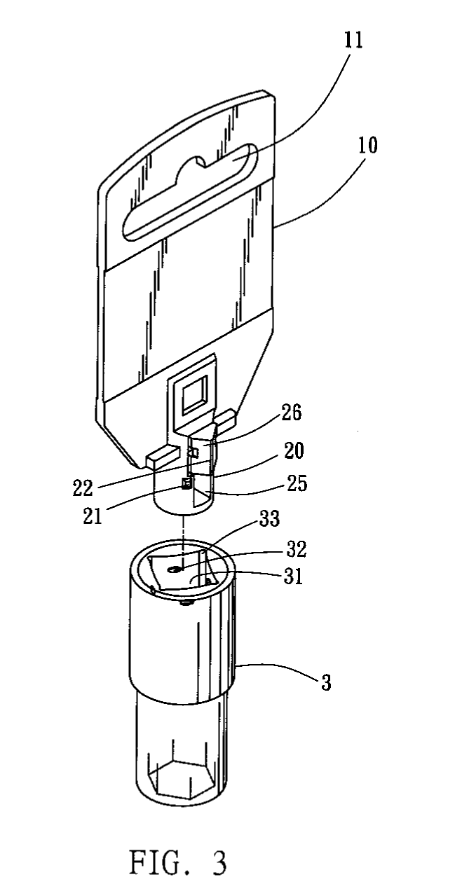

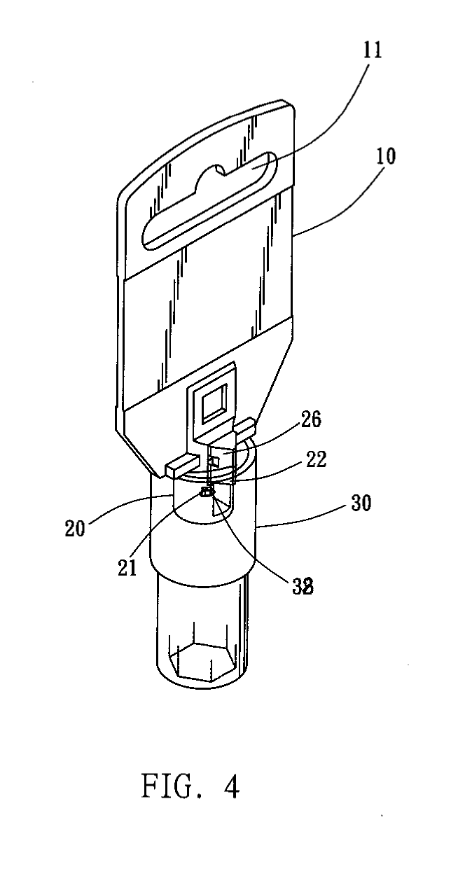

With reference to FIGS. 1 and 2B, the burglarproof socket exhibition assembly of the present invention is installed with a head 10 which is an oblong plate. An upper end of the head 10 is an exhibition unit 11. The exhibition unit 1 has a slot for suspending the exhibition assembly of the present invention to an object, such as a nail on a wall.

A lower side of the head 10 is formed as a tapered structure.

A body 20 is installed to a lower end of the head 10. The body 20 has a cylindrical structure. The body 20 has a hollow channel.

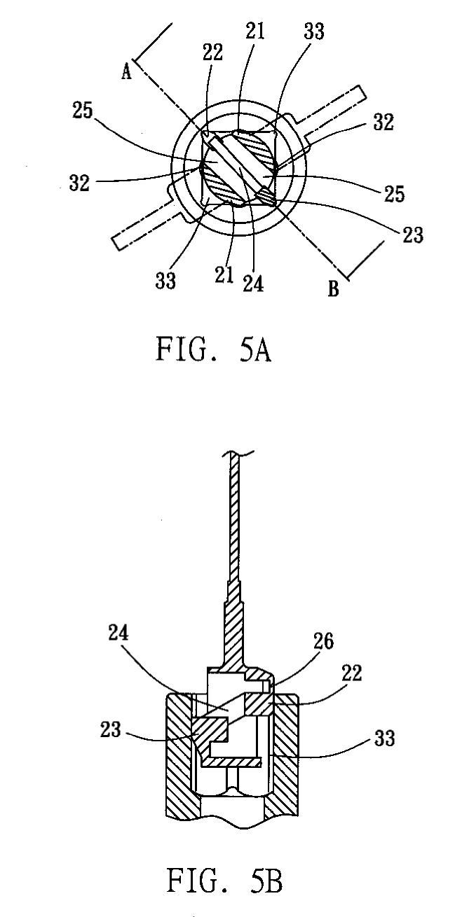

A front side of the hollow channel 38 of the body 20 has a first rib 22 and a rear side of the hollow channel of the body 20 has a second rib 23 (referring to FIGS. 5A and 5B). The first rib 22 is connected to the second rib 23 by using a bar 24 (referring to FIG. 1). The first rib 22 has a position higher than that of the second rib 23 (see FIG. 5B). Each rib 22, 23 is not adhered to a wall of the hollow channel 38 so that gaps 25 are formed between the rib 22, 23 and the hollow channel 38. The gap 25 provides a space for compressing the body 20 inwards.

A middle section 26 of the first rib 22 is reduced so as to have a small size (referring to FIG. 1).

Each of two sides of the front end of the body 20 has a protrusion 21. The two protrusions 21 are at two opposite sides of the hollow channel 38. Similarly, each of two sides of the rear end of the body 20 has a protrusion 21. The two protrusions 21 are at two opposite sides of the hollow channel 38. An angle between a middle of each rib, a center of the body 20, and the protrusion 21 is about 45 degrees.

Two transversal rods 27 are extended from two opposite sides of the body 20. The two transversal rods 27 are arranged at two sides of the hollow channel 38.

The application of the present invention will be described herein.

In application, referring to FIGS. 5A, and 5B, the burglarproof socket exhibition assembly of the present invention is inserted into a through hole 31 of a socket 3, and the protrusions 21 of the body 20 are buckled into the recesses 32 of the socket 3 in force. The transversal rod 27 extended from the body 20 will resist against an upper edge of the socket 3 so as to firmly retain the socket to the body 20 of the present invention. Thus, it is very difficult for a person to take out the socket 3.

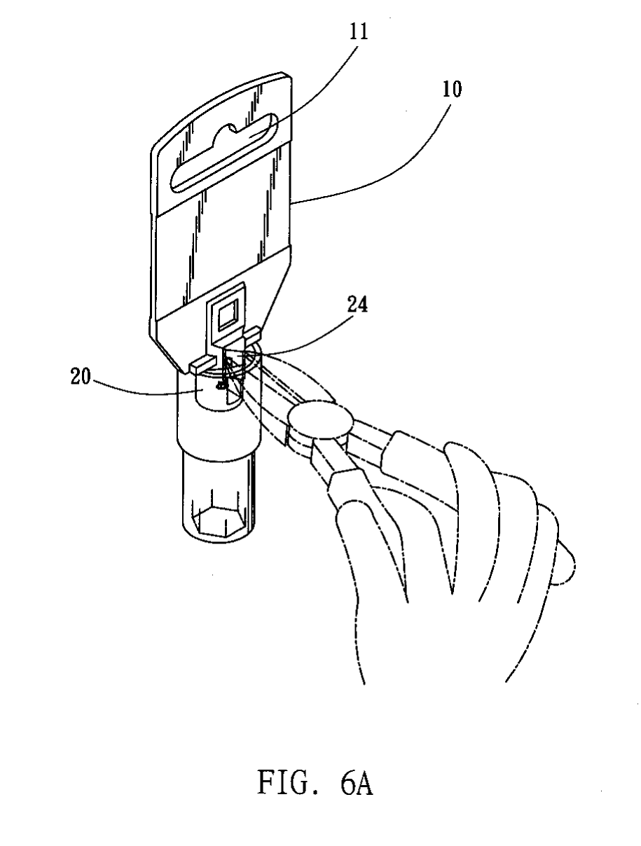

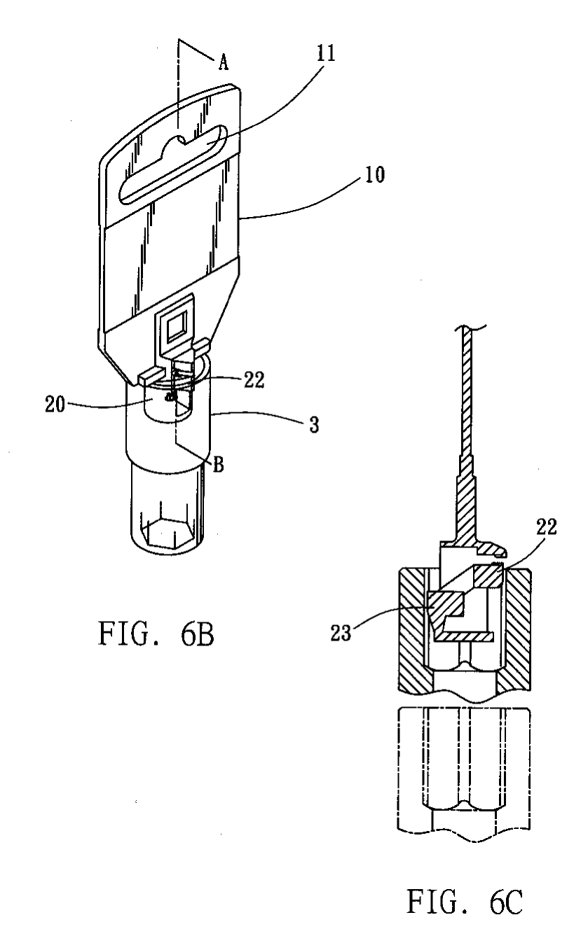

Referring to FIGS. 6A, 6B and 6C, if it is desired to withdraw the burglarproof socket exhibition assembly from the socket 3, it is only necessary to cut the rib 22 from the middle section 36 thereof. Then the socket 3 is rotated through an angle so that the protrusions 21 slide out of the recesses 32 to the corners 33. Then the burglarproof socket exhibition assembly is withdrew from the through hole 31 of the socket 3. Thus the socket 3 can be taken out.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A burglarproof socket exhibition assembly, comprising:
a head;
a body installed to a lower end of the head; the body having a cylindrical structure; the body having a hollow channel;
a front side of the hollow channel of the body having a first rib and a rear side of the hollow channel of the body having a second rib; the first rib having a position higher than that of the second rib; and
each of two sides of the front end of the body having a protrusion; the two protrusions being at two opposite sides of the hollow channel, each of two sides of the rear end of the body having a protrusion; and the two protrusions being at two opposite sides of the hollow channel.

2. The burglarproof socket exhibition assembly as claimed in claim 1, wherein an angle between a middle of each rib, a center of the body, and the protrusion being about 45 degrees.

3. The burglarproof socket exhibition assembly as claimed in claim 1, wherein the first rib is connected to the second rib by using a bar.

4. The burglarproof socket exhibition assembly as claimed in claim 1, wherein a middle section of the first rib being reduced so as to have a small size as a cutting portion.

6. The burglarproof socket exhibition assembly as claimed in claim 1, wherein an upper end of the head is an exhibition unit.

7. The burglarproof socket exhibition assembly as claimed in claim 1, wherein the exhibition unit has a slot for suspending the exhibition assembly to an object.

8. The burglarproof socket exhibition assembly as claimed in claim 1, wherein a lower side of the head is formed as a tapered structure.

9. The burglarproof socket exhibition assembly as claimed in claim 1, wherein each rib is not adhered to a wall of the hollow channel so that gaps are formed between the ribs and the hollow channel; and the gap provides a space for compressing the body inwards.

10. The burglarproof socket exhibition assembly as claimed in claim 1, wherein two transversal rods extend from two opposite sides of the body; and the two transversal rods are arranged at two sides of the hollow channel.
